(19) United States
(12) Patent Application Publication
(10) Pub. No.: US 2013/0047675 A1
(43) Pub. Date: Feb. 28, 2013

(54) FINISHING MOLD FOR SHAPING A GLASS ITEM, FOR EXAMPLE SUCH AS A GLASS BOTTLE

(71) Applicants: Sébastien Benoit, Bouttencourt (FR); François Louchet, Eu (FR)

(72) Inventors: Sébastien Benoit, Bouttencourt (FR); François Louchet, Eu (FR)

(21) Appl. No.: 13/559,484

(22) Filed: Jul. 26, 2012

(30) Foreign Application Priority Data
Jul. 29, 2011 (FR) 11 56966

(51) Int. Cl. C03B 9/347

(52) U.S. Cl. 65/360; 65/357; 65/359

(57) ABSTRACT

The invention relates to a finishing mold comprising a cavity for receiving a paraison the glass item and delimited by a central body arranged between a lid and a bottom. The central body is formed by an even number of complementary sectors at least equal to four, radially and simultaneously movable between an active position for molding the item from said paraison in which the sectors are laterally applied against one another, and a passive position for stripping the item in which said sectors are laterally spaced apart from one another.

### CROSS-REFERENCE TO RELATED APPLICATIONS

This application claims benefit of French patent application number 11 56966, filed Jul. 29, 2011, which is herein incorporated by reference.

### BACKGROUND OF THE INVENTION

1. Field of the Invention

The present invention relates to a finishing mold for shaping a glass item, for example such as a glass bottle.

2. Description of the Related Art

Generally, glass bottles are obtained by inserting at least one drop of glass, also called a paraison, into a cavity of a blanking mold and preforming a paraison, for example by blowing air into said blanking mold.

Then, the paraison thus formed is stripped and transferred by a handling arm, into a cavity of a finishing mold, and air is blown inside the paraison so as to definitively form the bottle.

Most often, the finishing mold is made up of an assembly consisting of two half-molds and drawers forming the cavity between them in which the paraison is placed. The drawers can be moved along a rectilinear path between an active position for molding the item from the paraison and a passive position for stripping the item.

However, the tendency for glass bottles, more particularly in the cosmetics and perfume field, is to make raised and/or hollow patterns on the outer wall of the bottle. To that end, raised and/or hollow patterns are made on the inner wall of the finishing mold such that those patterns are reproduced on the outer wall of the bottle when it is molded in said finishing mold.

However, it has been shown that this type of finishing mold with drawers is not adapted to this type of bottle, which poses problems during stripping, causing a deterioration of the raised and/or hollow patterns.

In fact, these finishing molds are not adapted to completely symmetrical stripping of the raised and/or hollow patterns, by ensuring homogenous thermics between the half-molds and the drawers and therefore guaranteeing a practically invisible sealing surface.

The invention aims to propose a finishing mold for shaping a glass item that makes it possible to avoid this type of drawback.

### SUMMARY OF THE INVENTION

The invention therefore relates to a finishing mold for shaping a glass item, such as a glass bottle for example, of the type comprising a cavity for receiving a paraison of said item and delimited by a central body arranged between a lid and a bottom, characterized in that the central body is formed by an even number of complementary sectors at least equal to four, radially and simultaneously movable between an active position for molding the item from said paraison in which the sectors are laterally applied against one another, and a passive position for stripping the item in which said sectors are spaced apart from one another.

According to other features of the invention:

the lid is formed from two half-lids each connected by a hinge pin to each adjacent sector of a sector half of the set of sectors,

the half-lids are connected to control means for controlling the movement of each half-lid between a closed position of the cavity and an open position of said cavity,

each half-lid comprises a central half-opening determining, in the closed position of said half-lids, an opening for positioning a neck of the paraison of the glass item,

the adjacent sectors of a sector half are connected to one another, opposite the lid, by a connecting member articulated on each of said sectors,

each connecting member includes a tab in the shape of an arc of circle,

the bottom comprises centering means for centering the sectors in the active position of said sectors,

the centering means include a rim formed on the bottom and protruding to the inside of the cavity, and a slot formed on the lower portion of each sector and designed each to cooperate with said rim,

the bottom comprises guide means for guiding the sectors between the active and passive positions, respectively, and

the guide means include a groove formed on the upper surface of the bottom and designed to cooperate with a roller positioned on the lower surface of the corresponding sector.

### BRIEF DESCRIPTION OF THE DRAWINGS

The features and advantages of the invention will appear in the following description, provided as an example and done in reference to the appended drawings, in which:

FIG. 1 is a perspective view of a first embodiment of a finishing mold, according to the invention, in the molding position,

FIG. 2 is a diagrammatic view in transverse cross-section of the central body of the finishing mold of FIG. 1,

FIG. 3 is a perspective view of a half-body and a half-lid of the finishing mold of FIG. 1,

FIG. 4 is a perspective side and partial bottom view of FIG. 3,

FIG. 5 is a perspective view of the bottom and of the guide means for guiding the sectors of the central body,

FIG. 6 is a top view of the bottom of the finishing mold of FIG. 1,

FIG. 7 is a perspective view similar to FIG. 1 with the finishing mold in the stripping position,

FIG. 8 is a perspective view of a second embodiment of a finishing mold, according to the invention, and

FIG. 9 is a perspective side and partial bottom view of FIG. 8.

### DETAILED DESCRIPTION

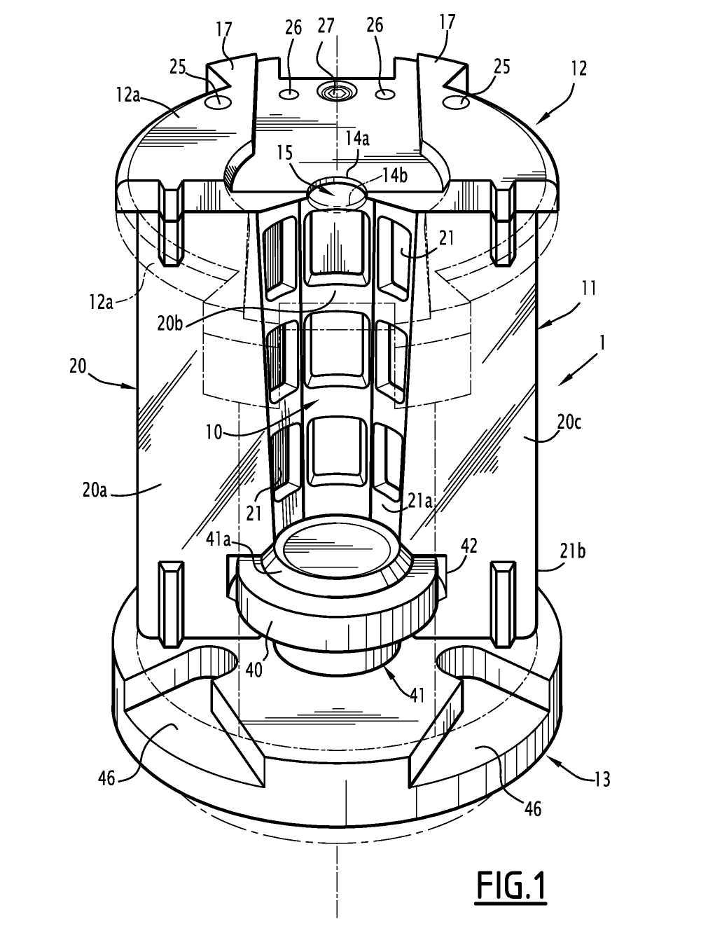

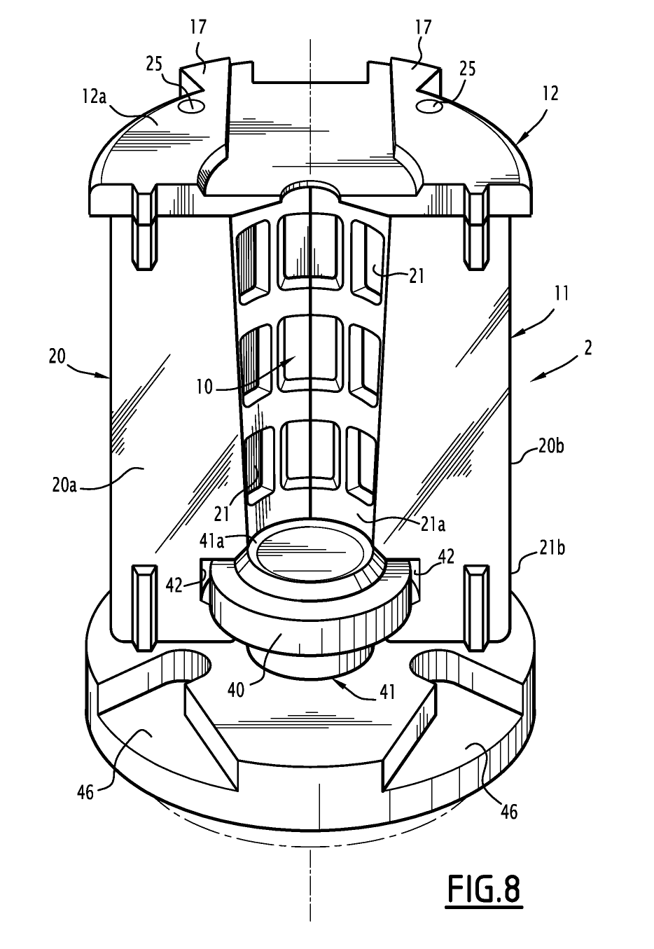

FIGS. 1 and 8 diagrammatically show two embodiments of a finishing mold, the finishing mold of FIG. 1 being designated by general reference 1 and the finishing mold of FIG. 8 being designated by general reference 2.

The elements shared by the two embodiments are designated using the same references in the following description.

The finishing molds 1 and 2 are designed to produce a glass item, for example such as a glass bottle, and preferably comprising at least one raised and/or hollow pattern on its outer surface.

As an example, the finishing molds 1 and 2 are designed to shape the glass bottle with a generally cylindrical shape and comprising a neck. The finishing mold according to the invention may also be designed to mold oval, elliptical, square or hexagonal bottles, or bottles in the shape of a star with six arms, for example.

The finishing mold 1 or 2 comprises a cavity 10 for receiving a paraison, not shown, preferably shaped. This cavity 10 is delimited by a central body 11 arranged between a lid 12 and a bottom 13.

In general, the central body 11 is formed from several identical and complementary sectors 20, provided in an even number greater than or equal to four.

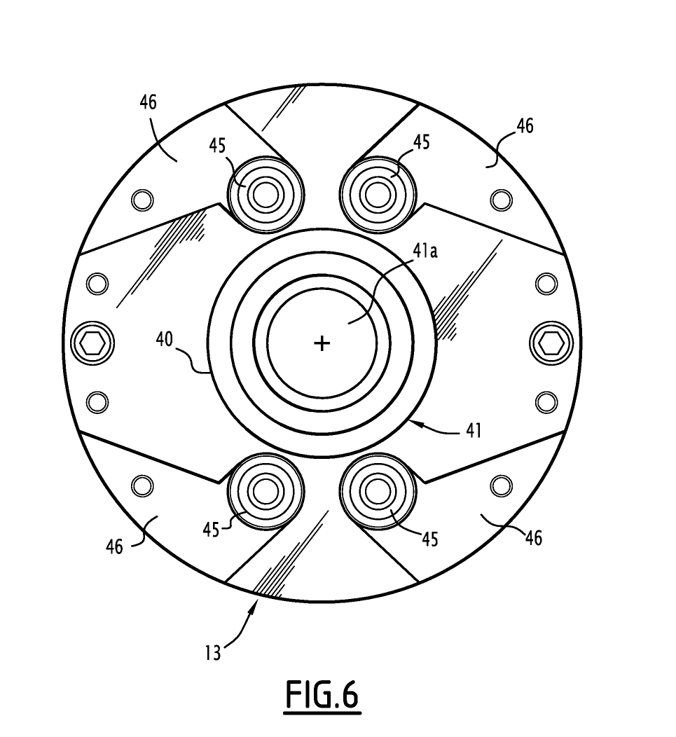

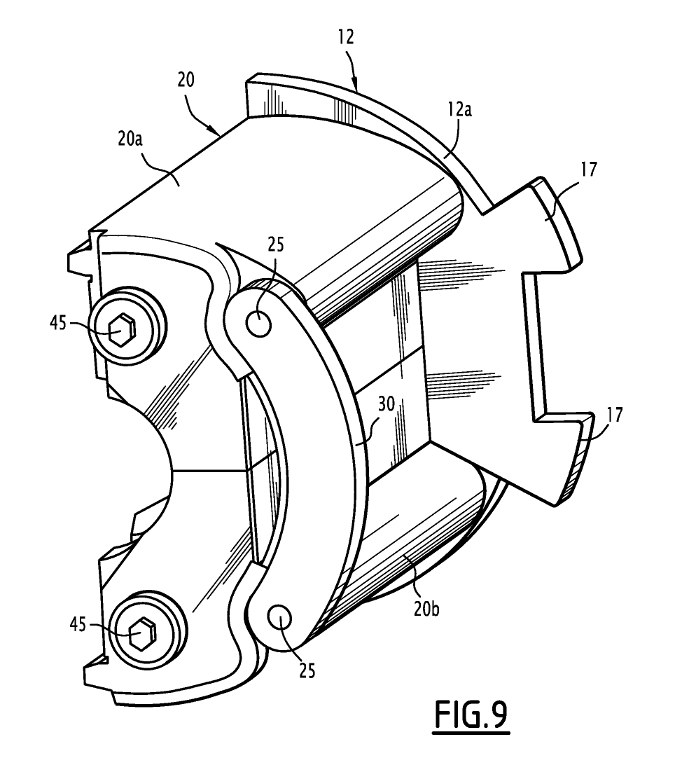

In the embodiment shown in FIGS. 1 to 7, the central body 11 of the finishing mold 10 comprises six complementary sectors 20 uniformly distributed around the cavity 10, and in the embodiment shown in FIGS. 8 and 9, the central body 11 of the finishing mold 2 comprises four complementary sectors 20 uniformly distributed around the cavity 10.

As illustrated in FIGS. 1 and 8, each sector 20 comprises an inner surface 21a having a profile in the shape of a cylinder portion and comprising raised and/or hollow patterns 21 designed to be formed on the outer surface of the glass bottle.

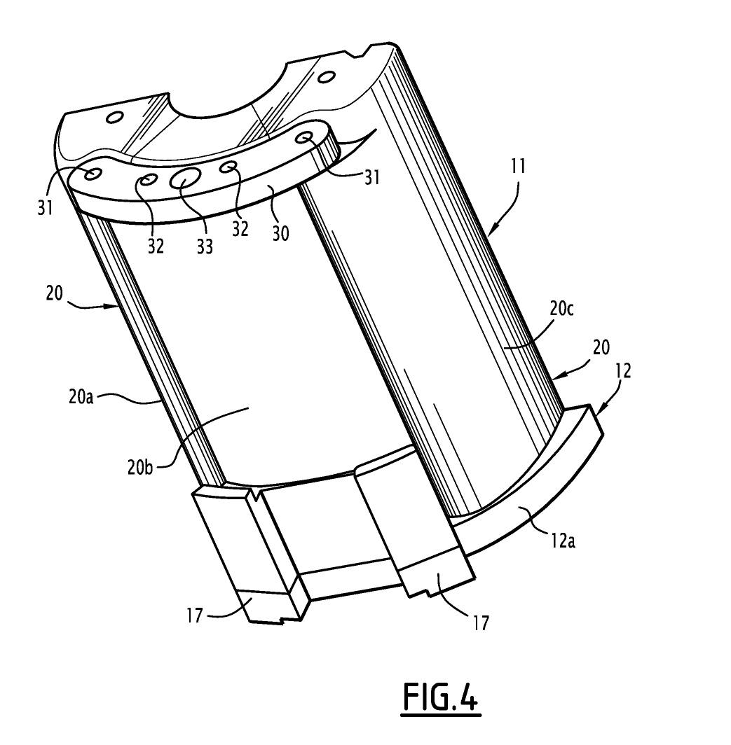

As shown in particular in FIGS. 4 and 9, the outer surface 21b of each sector 20 also has a profile in the shape of a cylinder portion.

The lid 12 is formed from two symmetrical half-lids 12a and 12b each comprising a central half-opening 14a and 14b determining, in the closed positions of the two half-lids 12a and 12b, i.e. when the two half-lids 12a and 12b are against one another, an opening 15 for positioning a neck, not shown, of the paraison of the glass item, placed in the cavity 10.

In general, the two half-lids 12a and 12b are connected to each sector 20 of a sector half 20 of the set of sectors.

In the embodiment shown in FIGS. 1 to 3, the half-lid 12a covers three sectors 20, respectively 20a, 20b, 20c, and the half-lid 12b also covers three sectors 20, respectively 20a, 20b, 20c.

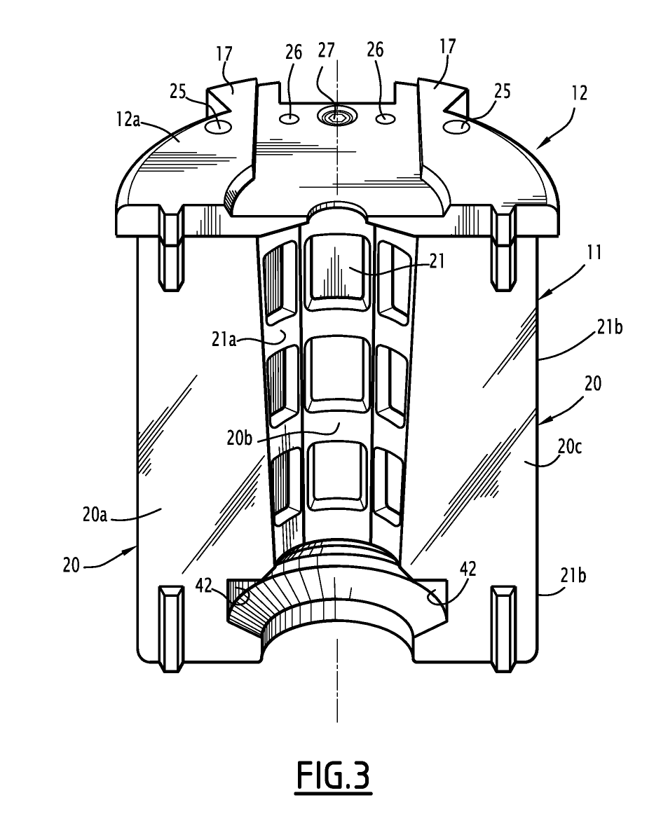

As shown in FIGS. 1 and 3, the half-lid 12a is connected to the two lateral sectors 20a and 20c, respectively, by a hinge pin 25, and said half-lid 12a is connected to the central sector 20b by two pins 26 and is fastened on that central sector 20b by a screwing member 27, for example such as a screw.

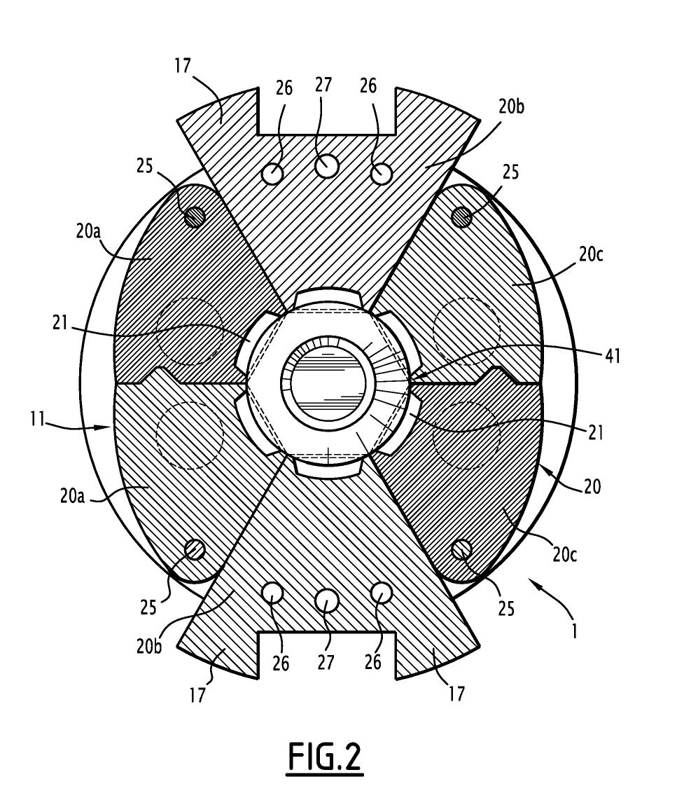

Likewise, the half-lid 12b is connected to the sector 20a, 20b, 20c of the other sector half 20 in a similar manner, as diagrammatically shown in FIG. 2.

The inner surfaces 21a of the three sectors 20a, 20b, 20c, respectively, cover a half-circumference of the cavity 10 of the finishing mold 1.

As shown in FIGS. 1, 2 and 4, each half-lid 12a, 12b as well as the upper portion of the central section 20b of each sector half 20, outwardly comprise two opposite lugs 17 designed to be connected by suitable means to control means, not shown, of a known type. These control means make it possible to move each half-lid 12a, 12b as well as the three corresponding sectors 20a, 20b, 20c between an active position for molding the item from the paraison, i.e. in the closed position of the cavity 10, and a passive position for stripping the item, i.e. in the open position of said cavity 10, as will be seen later.

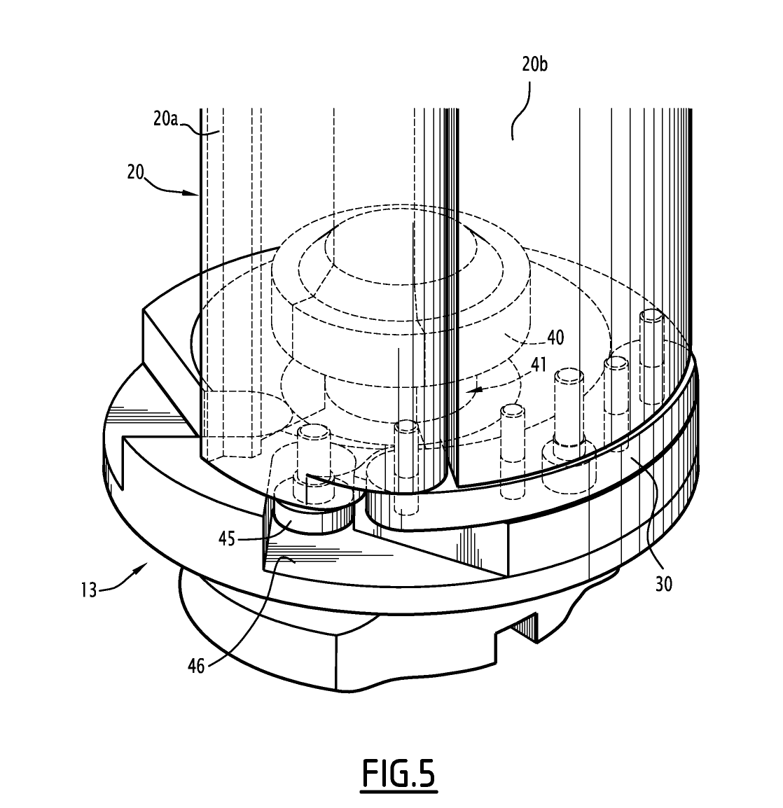

The adjacent sectors 20a, 20b, 20c of each sector half 20 are connected to each other, opposite the lid 12, by a connecting member made up of a tab 30 in the shape of an arc of circle (FIG. 4), and that tab 30 bears on the upper surface of the bottom 13 (FIG. 5). As shown in FIG. 4, the tab 30 is connected to each lateral sector 20a and 20c of the sector half 20 by a hinge pin 31, and said tab 30 is connected to the central sector 20b by two pins 32 and by a screwing member 33, for example formed by a screw.

The other sector half 20 also comprises a tab 30 in the shape of an arc of circle connected to the corresponding sectors 20a, 20b, 20c in a similar manner.

The bottom 13 of the finishing mold 1 or 2 comprises means for centering the sectors 20 in the active position of said sectors 20, the centering means being identical for the two embodiments.

The centering means include a rim 40 formed on a protruding portion 41 above the bottom 13 and whereof the upper surface 41 a forms the bottom of the cavity 10. This rim 40 is designed to cooperate with a slot 42 formed at the lower portion of each sector 20.

Lastly, the bottom 13 comprises guide means for guiding the sectors 20 between the active and passive positions, respectively.

According to the embodiment shown in FIGS. 1, 5 and 6, for the lateral sectors 20a and 20c of each sector half 20, the guide means include a roller 45 arranged on the lower surface of each of said sectors 20a and 20c. Each roller 45 cooperates with a groove 46 formed on the upper surface of the bottom 13.

The guiding of the central sector 20b during the movement of the sectors 20a, 20b, 20c is ensured by the tab 30, which slides on the upper surface of the bottom 13.

When a paraison is placed in the cavity 10 of the finishing mold 1, the control means are actuated and act on the two half-lids 12a and 12b so as to radially move said two half-lids 12a and 12b toward the outside.

Each half-lid 12a and 12b radially moves the three sectors 20a, 20b and 20c toward the outside. The central sector 20b slides on the upper surface of the bottom 13, and the lateral sectors 20a and 20c are radially driven toward the outside by the corresponding half-lid 12a or 12b, as well as by the tab 30. These two lateral sectors 20a and 20c pivot around pins 25 and 31 and are each guided by the roller 45, which moves in the corresponding groove 46.

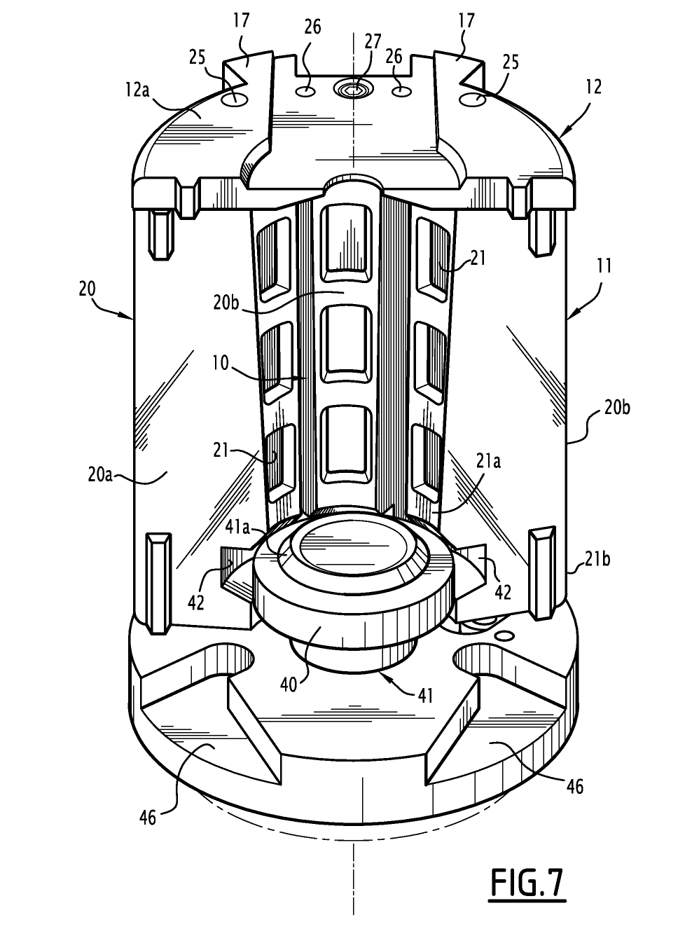

The slots 42 of sector 20 move away from the rim 40, as shown in FIG. 7.

The set of sectors 20, i.e. the six sectors 20 in the case of the first embodiment, are spaced away from one another and the two half-lids 12a and 12b are also spaced away from one another, allowing a paraison to be inserted into the cavity 10. This paraison is placed in the cavity 10 and rests on the upper surface 41 a of the portion 41.

To close the finishing mold 1, the control means are actuated in the opposite direction so as to return the sectors 20 to the active position in which those sectors 20 are laterally applied against one another and in which the half-lids 12a and 12b are applied against one another so as to determine the opening 15 in which the neck of the paraison is kept.

Then, air is injected into the paraison so as to form the glass bottle and so as to imprint the raised and/or hollow patterns 21 on the outer surface of the glass bottle.

After the shaping of the glass bottle, the finishing mold 1 is again opened by proceeding in a similar manner, and the glass bottle formed is removed from the cavity 10 of the finishing mold 1.

In the case of this second embodiment shown in FIGS. 8 and 9, the body 11 of the finishing mold 2 is formed by four identical and complementary sectors 20 uniformly distributed to form the cavity 10.

The lid 12 is also formed by two half-lids 12a and 12b, respectively, the half-lid 12a bearing two sectors 20 and the half-lid 12b also bearing two sectors 20.

The inner surface 21a of each sector 20 is in the shape of a cylinder portion, and the inner surfaces of those two sectors 20 cover a half-circumference of the cavity 10. The inner surface of each sector 20 comprises raised and/or hollow patterns 21 designed to be imprinted on the outer surface of the glass bottle.

The outer surface of each sector 20 also assumes the form of a cylinder portion.

Each half-lid 12a and 12b is connected to the two corresponding sectors 20 by a pin 25, and the centering and guiding means are also similar to the preceding embodiments and designated using the same references.

Also in this case, the two sectors 20 of a half-lid 12a or 12b are also connected to one another, opposite that half-lid, by a tab 30 in the shape of an arc of circle, as shown in FIG. 9.

In this embodiment, each lid 12a and 12b is connected to the tab 30 by the pin 25, which passes through the corresponding sector 20. Mechanical play is adjusted to allow the sectors 20a and 20b to pivot.

Each half-lid 12a and 12b also comprises lugs 17 designed to be connected by suitable members to control means, not shown.

The radial and simultaneous movement of the sectors 20 between the active position for molding the bottle from the paraison and in which the sectors are laterally applied against one another, and a passive position for stripping the bottle thus formed and in which said sectors are spaced apart from one another, is identical to the preceding embodiment.

The finishing mold according to the invention makes it possible to imprint raised and/or hollow patterns on the outer surface of the glass item, and to ensure the stripping of that type of item without damaging those patterns due to the movement kinematics of the elements making up that mold between the active molding position and the passive stripping position.

While the foregoing is directed to embodiments of the present invention, other and further embodiments of the invention may be devised without departing from the basic scope thereof, and the scope thereof is determined by the claims that follow.

1. A finishing mold for shaping a glass item, such as a glass bottle for example, of the type comprising a cavity for receiving a paraison of said item and delimited by a central body arranged between a lid and a bottom, wherein the central body is formed by an even number of complementary sectors at least equal to four, radially and simultaneously movable between an active position for molding the item from said paraison in which the sectors are laterally applied against one another, and a passive position for stripping the item in which said sectors are spaced apart from one another.

2. The finishing mold according to claim 1, wherein the lid is formed from two half-lids each connected by a hinge pin to each adjacent sector of a sector half of the set of sectors.

3. The finishing mold according to claim 2, wherein the half-lids are connected to control means for controlling the movement of each half-lid between a closed position of the cavity and an open position of said cavity.

4. The finishing mold according to claim 2, wherein each half-lid comprises a central half-opening determining, in the closed position of said half-lids, an opening for positioning a neck of the paraison of the glass item.

5. The finishing mold according to claim 1, wherein the adjacent sectors of a sector half are connected to one another, opposite the lid, by a connecting member articulated on each of said sectors.

6. The finishing mold according to claim 5, wherein each connecting member includes a tab in the shape of an arc of circle.

7. The finishing mold according to claim 1, wherein the bottom comprises centering means for centering the sectors in the active position of said sectors.

8. The finishing mold according to claim 7, wherein the centering means include a rim formed on the bottom and protruding to the inside of the cavity, and a slot formed on the lower portion of each sector and designed each to cooperate with said rim.

9. The finishing mold according to claim 1, wherein the bottom comprises guide means for guiding the sectors between the active and passive positions, respectively.

10. The finishing mold according to claim 9, wherein the guide means for guiding each sector include a groove formed on the upper surface of the bottom and designed to cooperate with a roller positioned on the lower surface of the corresponding sector.
